(19) United States
(12) Patent Application Publication
(10) Pub. No.: US 2024/0328865 A1
(43) Pub. Date: Oct. 3, 2024

(54) SYSTEM AND METHOD FOR SENSOR DRIVING VOLTAGE CONTROL

(71) Applicant: Honda Motor Co., Ltd., Tokyo (JP)

(72) Inventors: Tatsuya NAITO, Tokyo (JP); Mutsuki HIROOKA, Tokyo (JP); Kazuhiko KAMEDA, Tokyo (JP); Yuichi YOSHII, Tokyo (JP); Takuro HASHIMOTO, Tokyo (JP)

(73) Assignee: Honda Motor Co., Ltd., Tokyo (JP)

(21) Appl. No.: 18/423,336

(22) Filed: Jan. 26, 2024

(30) Foreign Application Priority Data
Mar. 29, 2023 (CN) 202310321707.1

(51) Int. Cl. G01K 1/00; G01K 13/00

(52) U.S. Cl. CPC G01K 1/00; G01K 13/00

(57) ABSTRACT

A system and method for sensor driving voltage control are provided. The system for sensor driving voltage control includes a sensor arranged on an outer side of a vehicle, an external temperature detector, and a control device. The external temperature detector is configured to detect an external temperature. The control device is configured to control a voltage value provided to the sensor and includes a voltage value determining unit configured to determine a voltage value for current supply to the sensor and a voltage value adjusting unit configured to adjust the voltage value determined by the voltage value determining unit. The voltage value determining unit sets a high voltage value higher than a normal voltage value when the external temperature detected by the external temperature detector is below a predetermined temperature. The normal voltage value is a voltage value set when the external temperature is above the predetermined temperature.

### CROSS-REFERENCE TO RELATED APPLICATION

This application claims the priority benefit of China application no. 202310321707.1, filed on Mar. 29, 2023. The entirety of the above-mentioned patent application is hereby incorporated by reference herein and made a part of this specification.

### BACKGROUND

### Technical Field

The disclosure relates to a control system and method, and in particular, relates to a system and method for sensor driving voltage control.

### Description of Related Art

A conventional camera heater is turned on by manual operation, so if the user forgets to turn on the camera heater or delay the time, an abnormality may occur or the elimination of the abnormality may be delayed. Further, since the camera heater will automatically turn off after a certain period of time, the abnormality may still exist or a new abnormality may surface depending on the external air conditions.

Patent Literature 1 (Japanese Patent Publication No. 2001-82441) provides a heater controller and a vehicle-mounted camera system. Based on whether there is an abnormality in the image, the external temperature, and the presence of external raindrops, and when the conditions are satisfied, power is supplied to the heater device, so that safety is improved and the heater device can operate efficiently.

However, Patent Literature 1 requires the installation of an independent heater device to eliminate an abnormality.

However, how to eliminate an abnormality without the installation of an independent heater device is a problem for designers in this field.

In view of the above, the disclosure aims to improve visibility in order to solve the abovementioned problems. Further, traffic safety can be further improved, thus contributing to the development of sustainable transportation systems.

### SUMMARY

To achieve the above, the disclosure provides a system for sensor driving voltage control including a sensor, an external temperature detector, and a control device. The sensor is arranged on an outer side of a vehicle. The external temperature detector is configured to detect an external temperature. The control device is configured to control a voltage value provided to the sensor. The control device includes a voltage value determining unit and a voltage value adjusting unit. The voltage value determining unit is configured to determine a voltage value for current supply to the sensor. The voltage value adjusting unit is configured to adjust the voltage value determined by the voltage value determining unit. The voltage value determining unit sets a high voltage value higher than a normal voltage value when the external temperature detected by the external temperature detector is below a predetermined temperature. The normal voltage value is a voltage value set when the external temperature is above the predetermined temperature. The disclosure further provides a method for sensor driving voltage control, and the method includes the following steps. An external temperature detector detects an external temperature. A voltage value provided to a sensor arranged on an outer side outside of a vehicle is controlled. The control includes determining a voltage value current supply to the sensor and adjusting the determined voltage value. Herein, a high voltage value higher than a normal voltage value is set when the external temperature detected by the external temperature detector is below a predetermined temperature. The normal voltage value is a voltage value set when the external temperature is above the predetermined temperature.

To make the aforementioned and other features and advantages of the disclosure more comprehensible, several embodiments accompanied with drawings are described in detail as follows.

### BRIEF DESCRIPTION OF THE DRAWINGS

FIG. 1 is a schematic block view illustrating a system for sensor driving voltage control according to an embodiment of the disclosure.

FIG. 2 is a flow chart illustrating a method for sensor driving voltage control according to an embodiment of the disclosure.

FIG. 3 is a graph illustrating changes in a sensor driving voltage according to an embodiment of the disclosure.

FIG. 4 is a flow chart illustrating a method for sensor driving voltage control according to an embodiment of the disclosure.

FIG. 5 is a graph illustrating changes in the sensor driving voltage according to an embodiment of the disclosure.

FIG. 6 is a graph illustrating changes in the sensor driving voltage according to an embodiment of the disclosure.

FIG. 7 is a graph illustrating changes in the sensor driving voltage according to an embodiment of the disclosure.

FIG. 8A and FIG. 8B are flow charts illustrating a method for sensor driving voltage control according to an embodiment of the disclosure.

### DESCRIPTION OF THE EMBODIMENTS

To achieve the above, the disclosure provides a system for sensor driving voltage control including a sensor, an external temperature detector, and a control device. The sensor is arranged on an outer side of a vehicle. The external temperature detector is configured to detect an external temperature. The control device is configured to control a voltage value provided to the sensor. The control device includes a voltage value determining unit and a voltage value adjusting unit. The voltage value determining unit is configured to determine a voltage value for current supply to the sensor. The voltage value adjusting unit is configured to adjust the voltage value determined by the voltage value determining unit. The voltage value determining unit sets a high voltage value higher than a normal voltage value when the external temperature detected by the external temperature detector is below a predetermined temperature. The normal voltage value is a voltage value set when the external temperature is above the predetermined temperature.

According to the structure, in the absence of an independent heater, when the external temperature is low, by supplying current with a high voltage higher than the normal voltage within a guaranteed voltage range, a camera is heated and the ice and snow attached to it can be melted.

In an embodiment of the disclosure, the high voltage value determined by the voltage value determining unit is determined by a maximum value within a guaranteed operating range.

According to the structure, in the absence of an independent heater, when the external temperature is low, by supplying current with the maximum value of the guaranteed voltage range, the camera is heated and the ice and snow attached to it can be melted.

In an embodiment of the disclosure, the control device further includes a high voltage supply time measuring unit for measuring a time of current supply with the high voltage value. The voltage value determining unit determines a low voltage value lower than the normal voltage value when the time measured by the high voltage supply time measuring unit exceeds a first predetermined time.

According to the structure, the attached snow melts after the predetermined time passes. By lowering the voltage to reduce the temperature of the camera, when the vehicle is driving, snow is blown up by the car in front, or snow falls, the ice and snow bounce off the surface of the camera lens without melting, thus reducing the adhesion of ice and snow.

In an embodiment of the disclosure, the control device further includes a low voltage supply time measuring unit for measuring a time of current supply with the low voltage value. Herein, the voltage value determining unit sets the high voltage value when the time measured by the low voltage supply time measuring unit exceeds a second predetermined time.

According to the structure, even if a current is supplied with the low voltage value, if the current is supplied for a long time, snow adhesion may occur, so the voltage is set to the high voltage value again for current supply to melt the snow.

In an embodiment of the disclosure, the system for sensor driving voltage control further includes a vehicle state detector configured to detect whether a state of the vehicle is an ignition off state or an ignition on state. Herein, the voltage value determining unit, when the state detected by the vehicle state detector is between the ignition on state and the ignition off state and the high voltage is set for the second time or more times, sets a second high voltage set for the second time or more times to be the same as a first high voltage set for the first time or to be a lower voltage value.

According to the structure, since the possibility of adhesion is reduced when the high voltage is set for the second time or more times, this voltage may be set lower than the high voltage set for the first time to alleviate the heat generated by the camera, so that the adhesion rate may be lowered, and the attached object may be melted.

In an embodiment of the disclosure, the system for sensor driving voltage control further includes a vehicle speed detector and a vehicle state detector. The vehicle speed detector is configured to detect a vehicle speed. The vehicle state detector is configured to detect whether a state of the vehicle is an ignition off state or an ignition on state. Herein, the voltage value determining unit, when the state detected by the vehicle state detector is between the ignition on state and the ignition off state, the high voltage is set for the second time or more times, and the vehicle speed detected by the vehicle speed detector is above a predetermined speed, sets the low voltage value.

According to the structure, since snow blown up while the vehicle is driving may adhere to the camera and melt into water, lowering the voltage prevents the attached snow from melting.

The disclosure further provides a method for sensor driving voltage control, and the method includes the following steps. An external temperature detector detects an external temperature. A voltage value provided to a sensor arranged on an outer side outside of a vehicle is controlled. The control includes determining a voltage value current supply to the sensor and adjusting the determined voltage value. Herein, a high voltage value higher than a normal voltage value is set when the external temperature detected by the external temperature detector is below a predetermined temperature. The normal voltage value is a voltage value set when the external temperature is above the predetermined temperature.

According to the method, in the absence of an independent heater, when the external temperature is low, by supplying current with a high voltage higher than the normal voltage within a guaranteed voltage range, a camera is heated and the ice and snow attached to it can be melted.

To sum up, in the system and method for sensor driving voltage control provided by the disclosure, by setting the voltage value for current supply to the sensor to a higher voltage value than the normal voltage value, the sensor is heated to melt the ice and snow attached thereto. By reducing the voltage value to the low voltage value after heating for a predetermined time, ice and snow adhesion can be reduced. In this way, the effect of eliminating sensor abnormalities may be achieved without installation of an independent heater device.

Descriptions of the disclosure are given with reference to the exemplary embodiments illustrated by the accompanying drawings. Wherever possible, the same reference numbers are used in the drawings and the description to refer to the same or like parts.

In the embodiments of the disclosure, a sensor is driven by providing a driving voltage, and the driving voltage has a specific range (e.g., between 5V and 9V) to ensure the operating quality of a camera. Herein, if the temperature outside is low when a vehicle is started, the driving voltage provided to the sensor is set to high (e.g., 9V). After driving is for a predetermined time with the driving voltage being set to a high state, the driving voltage is lowered (e.g., 5V). After driving with a low driving voltage for a long time, the driving voltage is set to high (e.g., 9V) again. When a vehicle speed exceeds a predetermined speed or a predetermined period of time passes, the driving voltage is set to low again. In this way, by setting the camera's drive voltage to high, the camera can be heated and snow can be melted without the need to install a separate device. Besides, the camera's own power supply can be turned off (0 V) when the drive voltage is lowered.

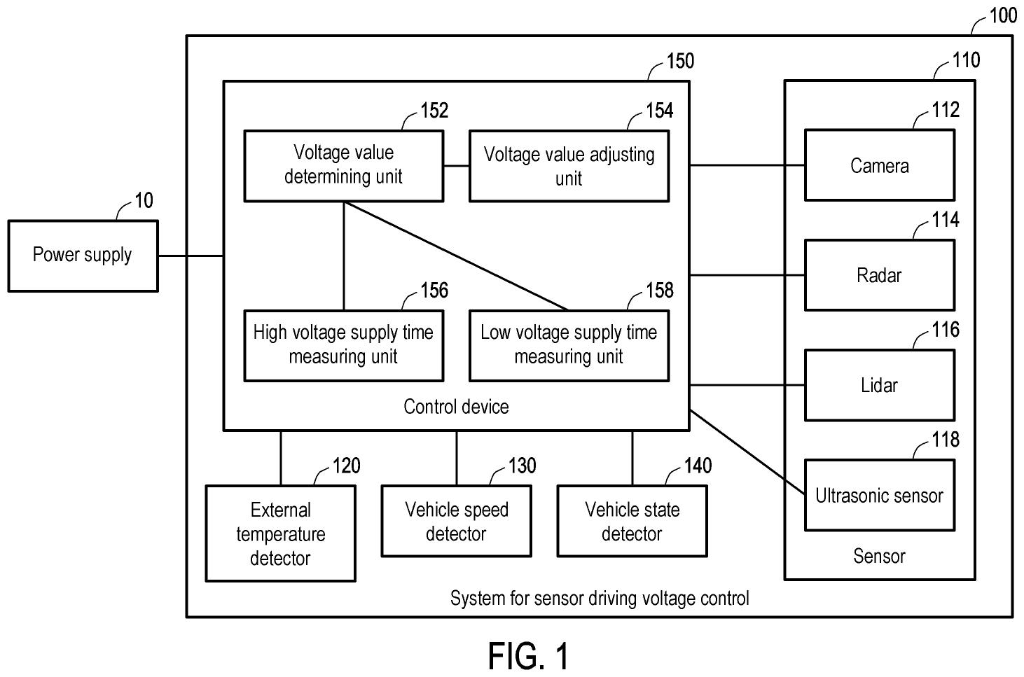

FIG. 1 is a schematic block view illustrating a system for sensor driving voltage control according to an embodiment of the disclosure. With reference to FIG. 1, a system for sensor driving voltage control 100 is arranged in a vehicle, for example. The vehicle is, for example, a car using an internal combustion engine such as a diesel engine or a gasoline engine as a power source, an electric car using an electric motor as a power source, a hybrid car having both an internal combustion engine and an electric motor, and the like.

As shown in FIG. 1, the system for sensor driving voltage control 100 includes a sensor 110, an external temperature detector 120, a vehicle speed detector 130, a vehicle state detector 140, and a control device 150.

The sensor 110 includes, for example, a camera 112, a radar 114, a laser radar (lidar) 116, and an ultrasonic sensor 118 or other sensors or detection devices, and their types are not limited in this embodiment. The sensor 110 is arranged on an outer side of a vehicle and is configured to detect the surrounding conditions of the vehicle, such as people, vehicles, or other obstacles located in front of or around the vehicle.

The external temperature detector 120 is arranged on the outside of the vehicle and is configured to detect an external temperature. In some embodiments, the external temperature detector 120 is arranged around the sensor 110 to detect the temperature around the sensor 110. The vehicle speed detector 130 is configured to detect a vehicle speed of the vehicle. The vehicle state detector 140 is configured to detect whether a state of the vehicle is an ignition off state or an ignition on state. Detection results of the external temperature detector 120, the vehicle speed detector 130, and the vehicle state detector 140 are to be transmitted to the control device 150, and the control device 150 then determines the internal and external environments and the state of the vehicle and accordingly controls a voltage provided to the sensor 110.

The control device 150 is implemented, for example, by a processor executing a program, by hardware such as a large scale integration (LSI) circuit or an application specific integrated circuit (ASIC), or by a combination of software and hardware, and the way of implementation thereof is not limited in this embodiment. The control device 110 operates with the power provided by a power supply 10 to control a driving voltage provided to the sensor 110 based on the detection results of the external temperature detector 120, the vehicle speed detector 130, and the vehicle state detector 140.

The control device 150 includes a voltage value determining unit 152, a voltage value adjusting unit 154, a high voltage supply time measuring unit 156, and a low voltage supply time measuring unit 158. Herein, the voltage value determining unit 152 is configured to determine a voltage value for current supply to the sensor 110. The voltage value adjusting unit 154 is configured to adjust the voltage value determined by the voltage value determining unit 152. The high voltage supply time measuring unit 156 is configured for measuring a time of current supply with a high voltage value. The low voltage supply time measuring unit 158 is configured for measuring a time of current supply with a low voltage value. Detailed implementation of these units is described in the following embodiments.

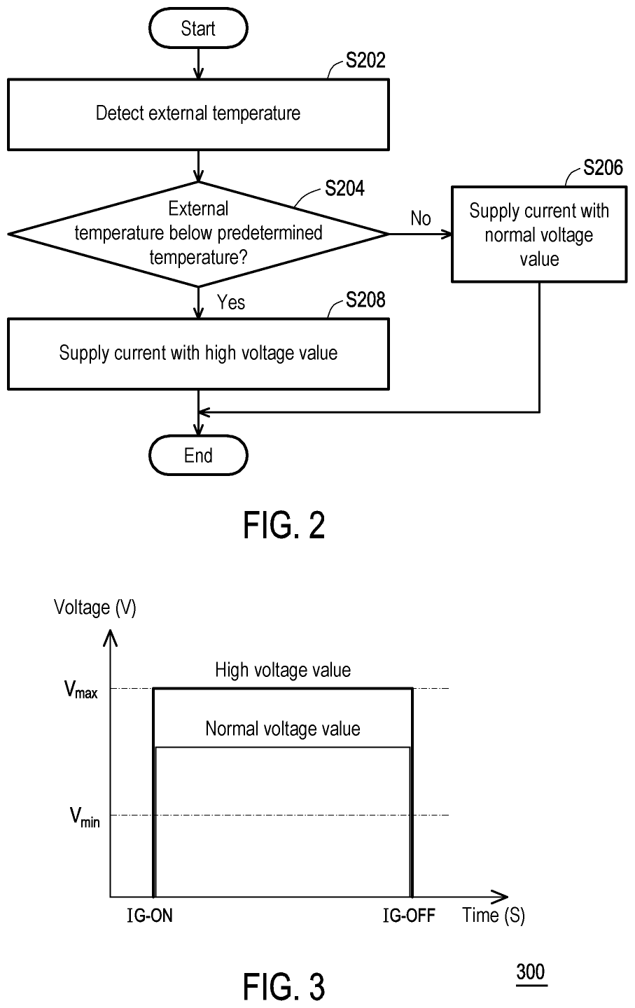

FIG. 2 is a flow chart illustrating a method for sensor driving voltage control according to an embodiment of the disclosure. With reference to FIG. 1 and FIG. 2 together, the method of this embodiment is applicable to the system for sensor driving voltage control 100 of FIG. 1. In the following paragraphs, the detailed steps of the method for sensor driving voltage control of this embodiment are described together with the components in the system for sensor driving voltage control 100.

In step S202, the external temperature detector 120 detects and transmits the external temperature to the control device 150.

In step S204, the voltage value determining unit 152 of the control device 150 determines whether the external temperature is below a predetermined temperature. The predetermined temperature is, for example, any temperature between −100 degrees and 10 degrees, and the range is not limited in this embodiment.

When it is determined that the external temperature is not below the predetermined temperature, in step S206, the voltage value determining unit 152 sets a voltage value for current supply to the sensor 110 to a normal voltage value. Further, the voltage value adjusting unit 154 adjusts the normal voltage value determined by the voltage value determining unit 152 to supply current to the sensor 110 with this normal voltage value. The normal voltage value is a voltage value set when the external temperature is above the predetermined temperature.

When it is determined that the external temperature is below the predetermined temperature, in step S206, the voltage value determining unit 152 sets the voltage value for current supply to the sensor 110 to the high voltage value higher than the normal voltage value. Further, the voltage value adjusting unit 154 adjusts the high voltage value determined by the voltage value determining unit 152 to supply current to the sensor 110 with this high voltage value.

In some embodiments, the voltage value determining unit selects a voltage value higher than the normal voltage value within a guaranteed operating range of the sensor 110 to determine the high voltage value. In this way, in the absence of an independent heater, when the external temperature is low, by supplying current with a high voltage higher than the normal voltage within the guaranteed voltage range, the camera may be heated and the ice and snow attached to it can be melted.

In some embodiments, the voltage value determining unit 152 directly determines the high voltage value based on a maximum value within the guaranteed operating range of the sensor 110. In this way, in the absence of an independent heater, when the external temperature is low, by supplying current with the maximum value of the guaranteed voltage range, the camera may be heated and the ice and snow attached to it can be melted.

For instance, FIG. 3 is a graph illustrating changes in a sensor driving voltage according to an embodiment of the disclosure. With reference to FIG. 3, a graph 300 of this embodiment illustrates the changes of the driving voltage provided to the sensor over time, in which the vertical axis is the driving voltage in volts (V), and the horizontal axis is time in seconds (s). Vₘₐₓ is a maximum value of a guaranteed operating voltage of the sensor, and Vₘᵢₙ is a minimum value of the guaranteed operating voltage of the sensor.

To be specific, in a high-temperature environment, since the sensor has no special problem within the guaranteed operating voltage range, in this embodiment, the voltage value of the driving voltage provided to the sensor is set to a normal voltage value around the middle of the guaranteed operating voltage range.

However, in an environment where the temperature is excessively low, the camera, radar, lidar, ultrasonic sensor and other sensors may be attached by ice, snow or fog, causing the camera's field of view to be blocked or the detection accuracy of the lidar to decrease. The guaranteed operating voltage is determined for each sensor and allows the voltage value used to drive the sensor.

In this embodiment, when the vehicle state is from the ignition on state (IG-ON) to the ignition off state (IG-OFF), the high voltage value is determined through the maximum value Vₘₐₓ of the guaranteed operating voltage of the sensor and is treated as the voltage value for current supply to the sensor. In this way, the sensor can be heated to melt the ice and snow attached to it without an independent heater, so that the sensor detection function may be restored to normal.

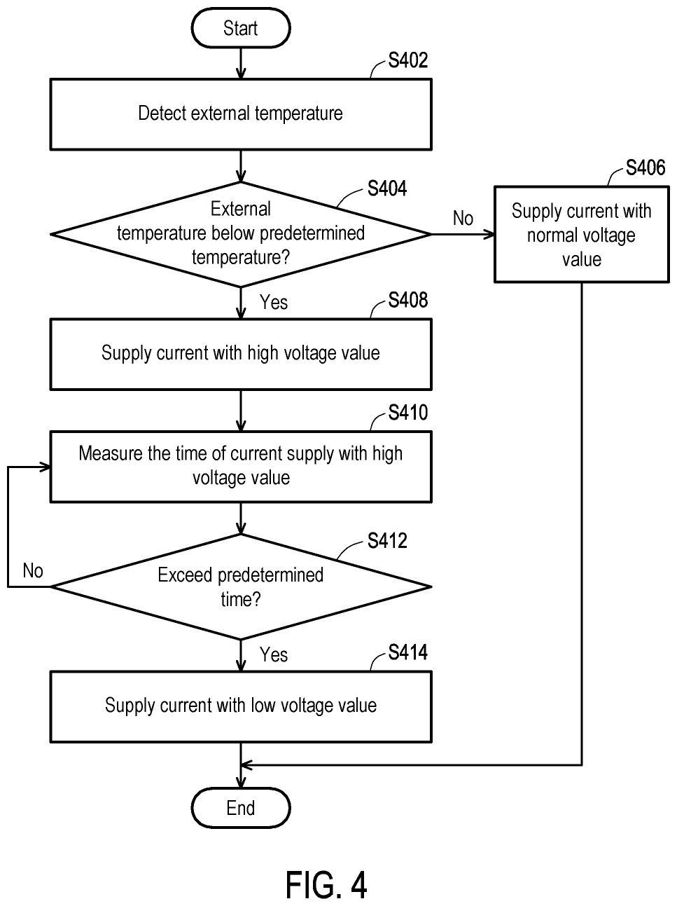

FIG. 4 is a flow chart illustrating a method for sensor driving voltage control according to an embodiment of the disclosure. With reference to FIG. 1 and FIG. 4 together, the method of this embodiment is applicable to the system for sensor driving voltage control 100 of FIG. 1. In the following paragraphs, the detailed steps of the method for sensor driving voltage control of this embodiment are described together with the components in the system for sensor driving voltage control 100.

In step S402, the external temperature detector 120 detects and transmits the external temperature to the control device 150.

In step S404, the voltage value determining unit 152 of the control device 150 determines whether the external temperature is below the predetermined temperature.

When it is determined that the external temperature is not below the predetermined temperature, in step S406, the voltage value determining unit 152 sets the voltage value for current supply to the sensor 110 to the normal voltage value. Further, the voltage value adjusting unit 154 adjusts the normal voltage value determined by the voltage value determining unit 152 to supply current to the sensor 110 with this normal voltage value. The normal voltage value is a voltage value set when the external temperature is above the predetermined temperature.

When it is determined that the external temperature is below the predetermined temperature, in step S408, the voltage value determining unit 152 sets the voltage value for current supply to the sensor 110 to the high voltage value higher than the normal voltage value. Further, the voltage value adjusting unit 154 adjusts the high voltage value determined by the voltage value determining unit 152 to supply current to the sensor 110 with this high voltage value.

The above steps S402 to S408 are identical or similar to the steps S202 to S208 provided in the foregoing embodiments, so description thereof is not provided in detail herein.

Different from the foregoing embodiments, in this embodiment, after the voltage value determining unit 152 supplies current to the sensor 110 with the high voltage value, in step S410, the high voltage supply time measuring unit 156 measures the time of current supply with the high voltage value. Further, in step S412, the voltage value determining unit 152 determines whether the time measured by the high voltage supply time measuring unit 156 exceeds a predetermined time.

If the predetermined time is not exceeded, step S410 is performed again, and the high voltage supply time measuring unit 156 continues to measure the time of current supply with the high voltage value.

If the predetermined time is exceeded, in step S414, the voltage value determining unit 152 sets the low voltage value lower than the normal voltage value. Further, the voltage value adjusting unit 154 adjusts the low voltage value determined by the voltage value determining unit 152 to supply current to the sensor 110 with this low voltage value.

In some embodiments, the voltage value determining unit selects a voltage value lower than the normal voltage value within the guaranteed operating range of the sensor 110 to determine the low voltage value. In some embodiments, the voltage value determining unit 152 directly determines the low voltage value based on the minimum value within the guaranteed operating range of the sensor 110.

To be specific, when the temperature of the sensor is high, the sensor can melt the attached ice and snow to obtain water, so when the temperature is low, the adhesion of ice and snow can be reduced. Therefore, in this embodiment, by supplying current to the sensor by increasing the voltage, the attached snow can be melted, and by lowering the voltage after a predetermined time to lower the temperature of the sensor, the adhesion of snow can be reduced.

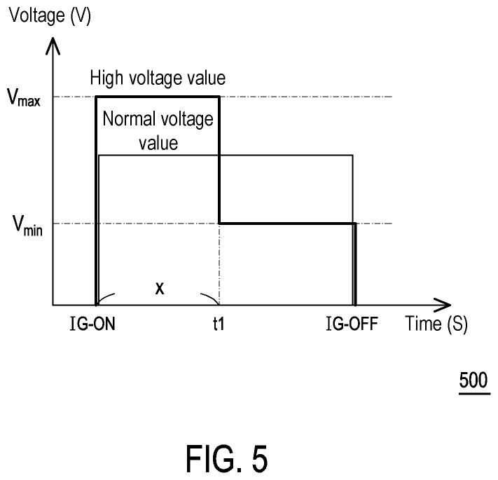

FIG. 5 is a graph illustrating changes in the sensor driving voltage according to an embodiment of the disclosure. With reference to FIG. 5, a graph 500 of this embodiment illustrates the changes of the driving voltage provided to the sensor over time, in which the vertical axis is the driving voltage in volts (V), and the horizontal axis is time in seconds (s). Vₘₐₓ is the maximum value of the guaranteed operating voltage of the sensor, and Vₘᵢₙ is the minimum value of the guaranteed operating voltage of the sensor.

To be specific, when the temperature of the sensor is high, the sensor can melt the attached ice and snow to obtain water, so when the temperature is low, the adhesion of ice and snow can be reduced. In this embodiment, when the vehicle state is changed to the ignition on state (IG-ON), that is, the high voltage value is determined through the maximum value Vₘₐₓ of the guaranteed operating voltage of the sensor and is treated as the voltage value for current supply to the sensor, the ice and snow attached to the sensor can be melted. At a time point t1 after x time passes, the low voltage value is determined through the minimum value Vₘᵢₙ of the guaranteed operating voltage of the sensor and is treated as the voltage value for current supply to the sensor, the temperature of the sensor can be lowered to reduce the adhesion of ice and snow. The duration of the x time may change according to the attached object (for example, whether snow is attached, whether ice film is formed, whether water droplets freeze, etc.). Further, the duration of time x may vary due to changes in temperature of the camera lens surface depending on the wind and weather conditions (snow, rain, wind, etc.) when driving.

It should be noted that in some embodiments, taking into account changes in the voltage values, a margin may be provided for the maximum value and the minimum value of the guaranteed operating voltage of the sensor. In other words, the voltage value to be set shall be higher or lower than the normal voltage, even if it is not the maximum value or the minimum value of the sensor's guaranteed operating voltage.

In some embodiments, after the voltage value determining unit 152 supplies current to the sensor 110 with the low voltage value, the control device 150 may measure a time for current supply with the low voltage value through the low voltage supply time measuring unit 158. Further, when the time measured by the low voltage supply time measuring unit 158 exceeds a predetermined time, the voltage value determining unit 152 sets the voltage value used by it for current supply to the sensor 110 back to the high voltage value.

In this way, even if a current is supplied with the low voltage value, if the current is supplied for a long time, snow adhesion may occur, so the voltage is set to the high voltage value again for current supply to melt the snow.

In some embodiments, by repeatedly setting the voltage value for current supply to the sensor 110 to the high voltage value and the low voltage value, the ice and snow attached to the sensor 110 can be melted, and the adhesion of ice and snow can also be reduced.

To be specific, in the system for sensor driving voltage control 100, the vehicle state detector 140 may detect whether the state of the vehicle is the ignition off state or the ignition on state. Further, the voltage value determining unit 152, when the state detected by the vehicle state detector is between the ignition on state and the ignition off state and the high voltage is set for the second time or more times, sets a second high voltage set for the second time or more times to be the same as a first high voltage set for the first time or to be a lower voltage value.

In this way, since the possibility of adhesion is reduced when the high voltage is set for the second time or more times, this voltage may be set lower than the high voltage set for the first time to alleviate the heat generated by the sensor (e.g., camera), so that the adhesion rate may be lowered, and the attached object may be melted.

In some embodiments, in the system for sensor driving voltage control 100, in addition to detecting whether the vehicle's state is the ignition off state or the ignition on state through the vehicle state detector 140, the vehicle speed is also detected through the vehicle speed detector 130. The voltage value determining unit 152, when the state detected by the vehicle state detector 140 is between the ignition on state and the ignition off state, the high voltage is set for the second time or more times, and the vehicle speed detected by the vehicle speed detector 130 is above a predetermined speed, sets the voltage value for current supply to the sensor 110 to the low voltage value. The predetermined vehicle speed is, for example, a speed at which winding may occur.

Therefore, since snow blown up while the vehicle is driving may adhere to the sensor (e.g., camera) and melt into water, lowering the voltage prevents the attached snow from melting.

For instance, FIG. 6 is a graph illustrating changes in a sensor driving voltage according to an embodiment of the disclosure. With reference to FIG. 6, a graph 600 of this embodiment illustrates the changes of the driving voltage provided to the sensor over time, in which the vertical axis is the driving voltage in volts (V), and the horizontal axis is time in seconds (s). Vₘₐₓ is the maximum value of the guaranteed operating voltage of the sensor, and Vₘᵢₙ is the minimum value of the guaranteed operating voltage of the sensor.

With reference to a voltage value change curve C1, in this embodiment, when the vehicle state is changed to the ignition on state (IG-ON), that is, the high voltage value is determined through the maximum value Vₘₐₓ of the guaranteed operating voltage of the sensor and is treated as the voltage value for current supply to the sensor, the ice and snow attached to the sensor can be melted.

At the time point t1 after x time passes, in this embodiment, the low voltage value is determined through the minimum value Vₘᵢₙ of the guaranteed operating voltage of the sensor and is treated as the voltage value for current supply to the sensor, so that the temperature of the sensor is lowered to reduce the adhesion of ice and snow.

At a time point t2 after z time passes, that is, when the power supply time using the low voltage value exceeds z time, in this embodiment, the voltage value used to supply current to the sensor 110 is set back to the high voltage value to melt the snow by setting the voltage to a high voltage value again for current supply. In this embodiment, the second high voltage set for the second time or more times is set to be the same as the first high voltage set for the first time. The z time is, for example, the time when snow is expected to adhere and impact.

At a time point t3 after x time passes, in this embodiment, the voltage value used to supply current to the sensor is set back to the low voltage value and is treated as the voltage value for current supply to the sensor. In this way, the temperature of the sensor decreases to reduce the adhesion of ice and snow until the state of the vehicle transitions to the ignition off state (IG-OFF).

It should be noted that, with reference to a voltage value change curve C2, it is detected that the speed of the vehicle reaches or exceeds the predetermined speed at a time point t4 in this embodiment. Therefore, the voltage value used to supply current to the sensor is set back to the low voltage value and is treated as the voltage value for current supply to the sensor. In this way, the snow attached to the sensor while the vehicle is driving may not melt until the state of the vehicle transitions to the ignition off state (IG-OFF).

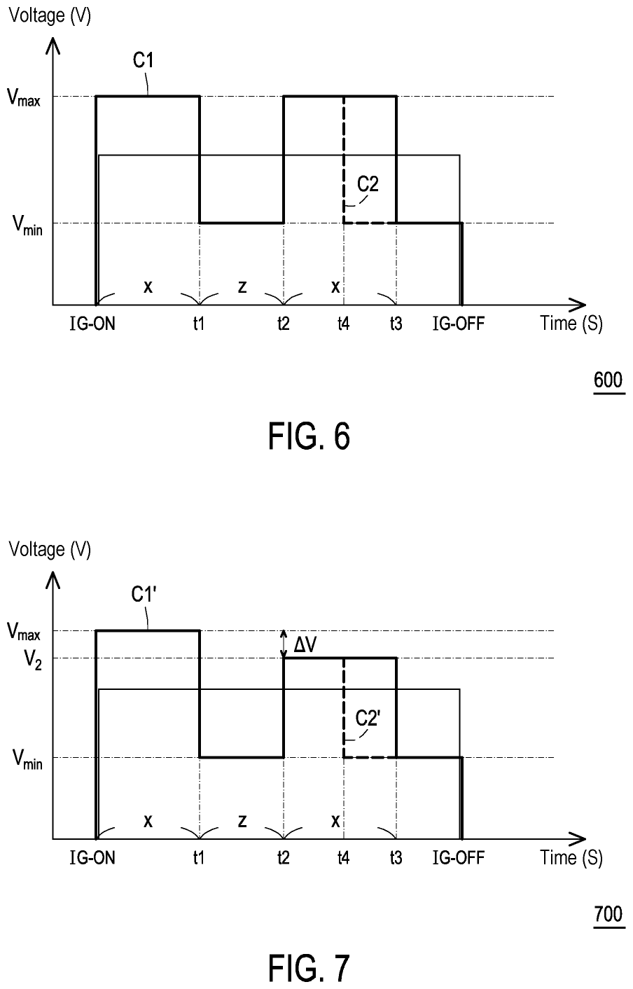

FIG. 7 is a graph illustrating changes in the sensor driving voltage according to an embodiment of the disclosure. With reference to FIG. 7, a graph 700 of this embodiment illustrates the changes of the driving voltage provided to the sensor over time, in which the vertical axis is the driving voltage in volts (V), and the horizontal axis is time in seconds (s). Vₘₐₓ is the maximum value of the guaranteed operating voltage of the sensor, and Vₘᵢₙ is the minimum value of the guaranteed operating voltage of the sensor.

With reference to a voltage value change curve C1′, in this embodiment, when the vehicle state is changed to the ignition on state (IG-ON), that is, the high voltage value is determined through the maximum value Vₘₐₓ of the guaranteed operating voltage of the sensor and is treated as the voltage value for current supply to the sensor, the ice and snow attached to the sensor can be melted.

At the time point t1 after x time passes, in this embodiment, the low voltage value is determined through the minimum value Vₘᵢₙ of the guaranteed operating voltage of the sensor and is treated as the voltage value for current supply to the sensor, so that the temperature of the sensor is lowered to reduce the adhesion of ice and snow.

At the time point t2 after z time passes, that is, when the power supply time using the low voltage value exceeds z time, in this embodiment, the voltage value used to supply current to the sensor 110 is set back to the high voltage value to melt the snow by setting the voltage to a high voltage value again for current supply. In this embodiment, the second high voltage set for the second time or more times is set to the high voltage value lower by ΔV than the first high voltage set for the first time. Since the possibility of adhesion is reduced when the high voltage is set for the second time or more times, by setting this voltage to be lower than the high voltage set for the first time may alleviate the heat generated by the camera, so that the adhesion rate may be lowered, and the attached object may be melted.

At the time point t3 after x time passes, in this embodiment, the voltage value used to supply current to the sensor is set back to the low voltage value and is treated as the voltage value for current supply to the sensor. In this way, the temperature of the sensor decreases to reduce the adhesion of ice and snow until the state of the vehicle transitions to the ignition off state (IG-OFF).

It should be noted that, with reference to a voltage value change curve C2′, it is detected that the speed of the vehicle reaches or exceeds the predetermined speed at the time point t4 in this embodiment. Therefore, the voltage value used to supply current to the sensor is set back to the low voltage value and is treated as the voltage value for current supply to the sensor. In this way, the snow attached to the sensor while the vehicle is driving may not melt until the state of the vehicle transitions to the ignition off state (IG-OFF).

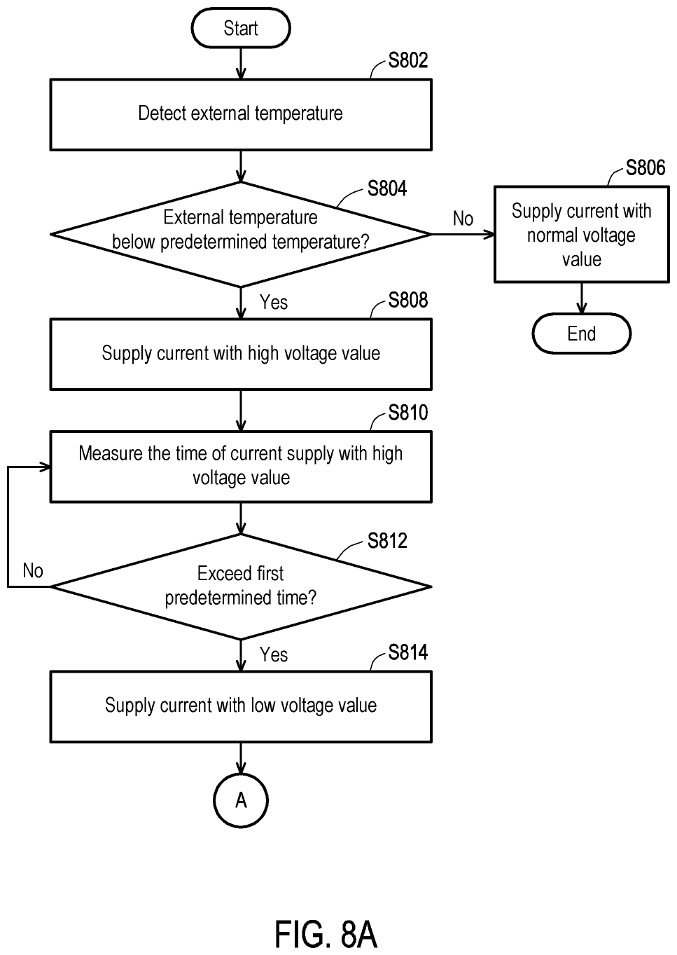

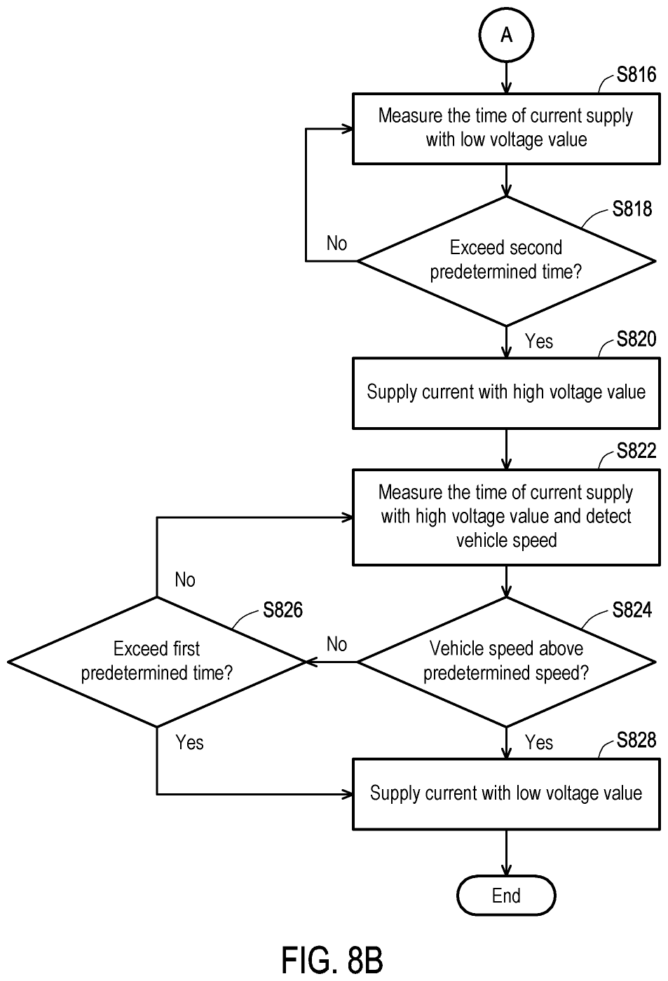

FIG. 8A and FIG. 8B are flow charts illustrating a method for sensor driving voltage control according to an embodiment of the disclosure. With reference to FIG. 1, FIG. 8A, and FIG. 8B together, the method of this embodiment is applicable to the system for sensor driving voltage control 100 of FIG. 1. In the following paragraphs, the detailed steps of the method for sensor driving voltage control of this embodiment are described together with the components in the system for sensor driving voltage control 100.

In step S802, the external temperature detector 120 detects and transmits the external temperature to the control device 150.

In step S804, the voltage value determining unit 152 of the control device 150 determines whether the external temperature is below the predetermined temperature.

When it is determined that the external temperature is not below the predetermined temperature, in step S806, the voltage value determining unit 152 sets the voltage value for current supply to the sensor 110 to the normal voltage value. Further, the voltage value adjusting unit 154 adjusts the normal voltage value determined by the voltage value determining unit 152 to supply current to the sensor 110 with this normal voltage value. The normal voltage value is a voltage value set when the external temperature is above the predetermined temperature.

When it is determined that the external temperature is below the predetermined temperature, in step S808, the voltage value determining unit 152 sets the voltage value for current supply to the sensor 110 to the high voltage value higher than the normal voltage value. Further, the voltage value adjusting unit 154 adjusts the high voltage value determined by the voltage value determining unit 152 to supply current to the sensor 110 with this high voltage value.

After current is supplied to the sensor 110 with the high voltage value, in step S810, the high voltage supply time measuring unit 156 measures the time of current supply with the high voltage value. Further, in step S812, the voltage value determining unit 152 determines whether the time measured by the high voltage supply time measuring unit 156 exceeds a first predetermined time.

If the first predetermined time is not exceeded, step S810 is performed again, and the high voltage supply time measuring unit 156 continues to measure the time of current supply with the high voltage value.

If the first predetermined time is exceeded, in step S814, the voltage value determining unit 152 sets the low voltage value lower than the normal voltage value. Further, the voltage value adjusting unit 154 adjusts the low voltage value determined by the voltage value determining unit 152 to supply current to the sensor 110 with this low voltage value.

The above steps S802 to S814 are identical or similar to the steps S402 to S414 provided in the foregoing embodiments, so description thereof is not provided in detail herein.

Different from the foregoing embodiments, in this embodiment, after the voltage value determining unit 152 supplies current to the sensor 110 with the low voltage value, in step S816, the low voltage supply time measuring unit 158 measures the time of current supply with the low voltage value. Further, in step S818, the voltage value determining unit 152 determines whether the time measured by the low voltage supply time measuring unit 158 exceeds a second predetermined time.

If the second predetermined time is not exceeded, step S816 is performed again, and the low voltage supply time measuring unit 158 continues to measure the time of current supply with the low voltage value.

If the second predetermined time is exceeded, in step S820, the voltage value determining unit 152 sets the voltage value for current supply to the sensor 110 to the high voltage value. Further, the voltage value adjusting unit 154 adjusts the high voltage value determined by the voltage value determining unit 152 to supply current to the sensor 110 with this high voltage value.

Since the voltage value is increased for the second time in step S820, in step S822 in this embodiment, the high voltage supply time measuring unit 156 measures the time for current supply with the high voltage value, and the vehicle speed detector 130 detects the vehicle speed. Further, in step S804, the voltage value determining unit 152 determines whether the vehicle speed is equal to or higher than the predetermined speed. Herein, the predetermined speed is, for example, a speed between 1 and 100 kilometers/hour (km/h).

If the vehicle speed does not reach the predetermined speed, in step S826, the voltage value determining unit 152 further determines whether the time measured by the high voltage supply time measuring unit 156 exceeds the first predetermined time.

If the first predetermined time is not exceeded, step S810 is performed again, and the high voltage supply time measuring unit 156 continues to measure the time of current supply with the high voltage value.

If the voltage value determining unit 152 determines that the time measured by the high voltage supply time measuring unit 156 exceeds the first predetermined time, or the vehicle speed reaches above the predetermined speed, in step S828, the voltage value determining unit 152 sets the low voltage value lower than the normal voltage value. Further, the voltage value adjusting unit 154 adjusts the low voltage value determined by the voltage value determining unit 152 to supply current to the sensor 110 with this low voltage value.

It should be noted that in the above embodiments, it is determined whether to increase the voltage value for current supply to the sensor based on the external temperature. However, in other embodiments, if ice and snow adhere to the camera lens while driving, visibility will be deteriorated. In such a case, an ice and snow adhesion detecting unit can detect ice and snow adhesion from an image captured by the camera, so that the voltage value for current supply to the sensor is increased to raise the temperature of the camera lens surface to prevent ice formation. Alternatively, in other embodiments, an ice and snow melting button may also be provided on the vehicle, so that the driver can prevent the surface of the camera lens from freezing according to actual weather conditions by pressing the button. Alternatively, in other embodiments, the sensor may not be covered by snow or ice even if the external temperature is below the predetermined temperature. In this case, the voltage value may be set lower from the beginning without increasing the voltage value used to provide current to the sensor.

In view of the foregoing, in the system and method for sensor driving voltage control provided by the disclosure, when an excessively low temperature outside the vehicle is detected, by setting the voltage value for current supply to the sensor to a higher voltage value than the normal voltage value, the sensor may be heated to melt the ice and snow attached thereto. By switching the abovementioned voltage value back and forth between the high voltage value and the low voltage value, ice and snow can be melted and ice and snow adhesion may also be lowered.

In addition, when a high vehicle speed is detected, by setting the voltage value for current supply to the sensor to the low voltage value, the ice and snow attached to the sensor may be prevented from melting. In this way, the effect of eliminating sensor abnormalities may be achieved without installation of an independent heater device.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

What is claimed is:

1. A system for sensor driving voltage control, comprising:
a sensor, arranged on an outer side of a vehicle;
an external temperature detector, detecting an external temperature; and
a control device, controlling a voltage value provided to the sensor, wherein
the control device comprises:
a voltage value determining unit, determining a voltage value for current supply to the sensor; and
a voltage value adjusting unit, adjusting the voltage value determined by the voltage value determining unit, wherein
the voltage value determining unit sets a high voltage value higher than a normal voltage value when the external temperature detected by the external temperature detector is below a predetermined temperature, and the normal voltage value is a voltage value set when the external temperature is above the predetermined temperature.

2. The system for sensor driving voltage control according to claim 1, wherein
the high voltage value determined by the voltage value determining unit is determined by a maximum value within a guaranteed operating range.

3. The system for sensor driving voltage control according to claim 1, wherein
the control device further comprises a high voltage supply time measuring unit for measuring a time of current supply with the high voltage value, wherein
the voltage value determining unit sets a low voltage value lower than the normal voltage value when the time measured by the high voltage supply time measuring unit exceeds a first predetermined time.

4. The system for sensor driving voltage control according to claim 3, wherein
the control device further comprises a low voltage supply time measuring unit for measuring a time of current supply with the low voltage value, wherein
the voltage value determining unit sets the high voltage value when the time measured by the low voltage supply time measuring unit exceeds a second predetermined time.

5. The system for sensor driving voltage control according to claim 4, further comprising:
a vehicle state detector to detect whether a state of the vehicle is an ignition off state or an ignition on state, wherein
the voltage value determining unit,
when the state detected by the vehicle state detector is between the ignition on state and the ignition off state and the high voltage is set for the second time or more times,
sets a second high voltage set for the second time or more times to be the same as a first high voltage set for the first time or to be a lower voltage value.

6. The system for sensor driving voltage control according to claim 4, further comprising:
a vehicle speed detector, detect a vehicle speed; and
a vehicle state detector to detect whether a state of the vehicle is an ignition off state or an ignition on state, wherein
the voltage value determining unit,
when the state detected by the vehicle state detector is between the ignition on state and the ignition off state, the high voltage is set for the second time or more times, and the vehicle speed detected by the vehicle speed detector is above a predetermined speed, set the low voltage value.

7. A method for sensor driving voltage control, comprising:
detecting, by an external temperature detector, an external temperature;
controlling a voltage value provided to a sensor arranged on an outer side of a vehicle, comprising:
determining a voltage value for current supply to the sensor; and
adjusting the determined voltage value, wherein
a high voltage value higher than a normal voltage value is set when the external temperature detected by the external temperature detector is below a predetermined temperature, and the normal voltage value is a voltage value set when the external temperature is above the predetermined temperature.
